(19) United States
(12) Patent Application Publication
(10) Pub. No.: US 2024/0311058 A1
(43) Pub. Date: Sep. 19, 2024

(54) SERVICE PROVIDING SYSTEM, SERVICE PROVIDING APPARATUS, AND DEVICE

(71) Applicant: SEIKO EPSON CORPORATION, TOKYO (JP)

(72) Inventor: Tetsuyuki MINAMIHARA, SHIOJIRI-SHI (JP)

(21) Appl. No.: 18/605,210

(22) Filed: Mar. 14, 2024

(30) Foreign Application Priority Data
Mar. 14, 2023 (JP) 2023-039395

(51) Int. Cl. G06F 3/12

(52) U.S. Cl. CPC G06F 3/1204; G06F 3/1238; G06F 3/1285

(57) ABSTRACT

A service providing system including a device that uses a cloud service, a service providing apparatus that provides the cloud service, and an information processing apparatus, the device transmits device identification information for identifying the device to the service providing apparatus, the information processing apparatus acquires the device identification information from the device, and after logging in to the cloud service, transmits the device identification information to the service providing apparatus, and the service providing apparatus transmits, to the device, usage permission information for permitting use of the cloud service when the device identification information received from the device coincides with the device identification information received from the information processing apparatus, and the device uses the cloud service of the service providing apparatus by using the usage permission information.

The present application is based on, and claims priority from JP Application Serial Number 2023-039395, filed Mar. 14, 2023, the disclosure of which is hereby incorporated by reference herein in its entirety.

### BACKGROUND

### 1. Technical Field

The present disclosure relates to a service providing system, a service providing apparatus, a device, and a program.

### 2. Related Art

In the related art, a technique is known in which a license key issued from a server is registered in a printer in order for the printer to use a service provided by the server. JP-A-2021-056596 discloses a technique in which a license key issued by a server is inputted to a printer to complete setting for the printer to use a monitoring service provided by the server.

However, in the related art, in order for a device such as a printer to use a cloud service, a user needs to set a key issued in the cloud service to the printer by operating an apparatus such as a PC. In order to set the key, it is necessary to perform an operation of inputting information of the key transmitted to the apparatus that the user uses by e-mail to a key input screen to the printer, and there is a problem of lack of usability.

### SUMMARY

The present disclosure for achieving the above object is a service providing system including: a device that uses a cloud service; a service providing apparatus that provides the cloud service; and an information processing apparatus, in which the device transmits device identification information for identifying the device to the service providing apparatus, the information processing apparatus acquires the device identification information from the device, and after logging in to the cloud service, transmits the device identification information to the service providing apparatus, the service providing apparatus transmits, to the device, usage permission information for permitting use of the cloud service when the device identification information received from the device coincides with the device identification information received from the information processing apparatus, and the device uses the cloud service of the service providing apparatus by using the usage permission information.

According to another aspect of the present disclosure for achieving the above object, there is provided a service providing apparatus that provides a cloud service and configured to communicate with a device that uses the cloud service and an information processing apparatus, the service providing apparatus including: a reception processing unit that receives, from the device, device identification information for identifying the device, and further receives, from the information processing apparatus, the device identification information inputted to the information processing apparatus; and a transmission processing unit that transmits, to the device, usage permission information for permitting use of the cloud service when the device identification information received from the information processing apparatus coincides with the device identification information received from the device.

According to another aspect of the present disclosure for achieving the above object, there is provided a device configured to communicate with a service providing apparatus that provides a cloud service, the device using the cloud service and including: a transmission processing unit that transmits, to the service providing apparatus, device identification information for identifying the device; a reception processing unit that receives usage permission information for permitting use of the cloud service, the usage permission information being transmitted from the service providing apparatus when the device identification information transmitted from the device to the service providing apparatus coincides with the device identification information transmitted from an information processing apparatus to the service providing apparatus; and a using unit that uses the cloud service of the service providing apparatus by using the usage permission information.

According to another aspect of the present disclosure for achieving the above object, there is provided a program for causing a computer of a service providing apparatus that is an apparatus providing a cloud service and configured to communicate with a device that uses the cloud service and an information processing apparatus to function as a reception processing unit that receives, from the device, device identification information for identifying the device and further receives, from the information processing apparatus, the device identification information inputted to the information processing apparatus, and a transmission processing unit that transmits, to the device, usage permission information for permitting use of the cloud service when the device identification information received from the information processing apparatus coincides with the device identification information received from the device.

According to another aspect of the present disclosure for achieving the above object, there is provided a program for causing a computer of a device configured to communicate with a service providing apparatus that provides a cloud service and to use the cloud service to function as a transmission processing unit that transmits, to the service providing apparatus, device identification information for identifying the device, a reception processing unit that receives usage permission information for permitting use of the cloud service, the usage permission information being transmitted from the service providing apparatus when the device identification information transmitted from the device to the service providing apparatus coincides with the device identification information transmitted from an information processing apparatus to the service providing apparatus, and a using unit that uses the cloud service of the service providing apparatus by using the usage permission information.

### BRIEF DESCRIPTION OF THE DRAWINGS

FIG. 1 is an overall configuration diagram of a service providing system.

FIG. 2 is a configuration diagram of a service providing apparatus.

FIG. 3 is a configuration diagram of a printer.

FIG. 4 is a configuration diagram of a user apparatus.

FIG. 5 is an explanatory diagram of an outline of a setting process.

FIG. 6 is a sequence diagram illustrating a setting process.

FIG. 7 is an explanatory diagram illustrating the setting process.

FIG. 8 is a sequence diagram illustrating a service providing process.

### DESCRIPTION OF EMBODIMENTS

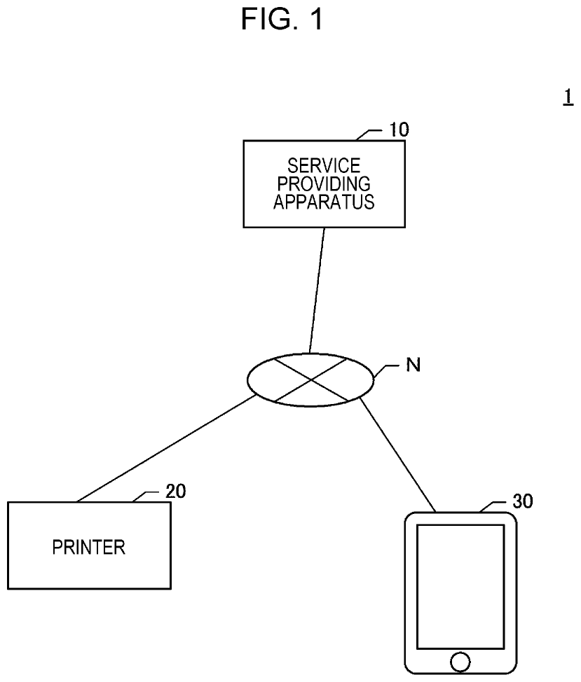

FIG. 1 is an overall configuration diagram of a service providing system 1 according to an embodiment. The service providing system 1 includes a service providing apparatus 10, a printer 20, and a user apparatus 30. The service providing apparatus 10, the printer 20, and the user apparatus 30 are connected to each other via a network N.

The service providing apparatus 10 is a server apparatus that provides a cloud service. The cloud service is a service for monitoring and managing a target device. The service providing apparatus 10 of the present embodiment provides the cloud service to the printer 20 as a device. The printer 20 is an example of the device that uses the cloud service. Although only one printer 20 is illustrated in FIG. 1, the service providing apparatus 10 provides the cloud service to a plurality of printers 20.

In the service providing system 1, a device that uses the cloud service is managed for each organization unit to which the device belongs. Here, the organization is a group to which a plurality of users belong, such as a company or a business site. The service providing apparatus 10 registers the device that uses the cloud service in association with an organization, and issues an agent key necessary for using the cloud service. Then, the service providing apparatus 10 manages the printer 20 for each organization unit, and performs notification to an apparatus such as a PC used by the organization when, for example, an error occurs in the printer 20. Here, the agent key is an example of usage permission information for permitting use of the cloud service.

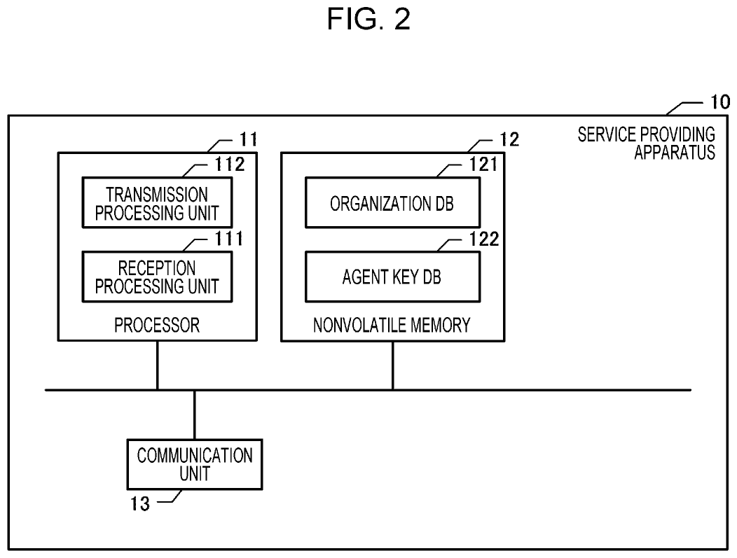

FIG. 2 is a configuration diagram of the service providing apparatus 10. The service providing apparatus 10 includes a processor 11, a nonvolatile memory 12, and a communication unit 13. The processor 11 includes a CPU, a ROM, a RAM, and the like (not illustrated), executes various programs recorded in the nonvolatile memory 12, and can control each unit of the service providing apparatus 10. Note that, the processor 11 may be configured by a single chip, may be configured by a plurality of chips, or may be configured as an SoC together with various functional blocks. In addition, the processor 11 may include, for example, an ASIC instead of the CPU, or may be realized by cooperation between the CPU and the ASIC.

The processor 11 functions as a reception processing unit 111 and a transmission processing unit 112 by executing a program stored in the nonvolatile memory 12, the ROM, or the like. That is, in the following description, processing described as being executed by the reception processing unit 111 and the transmission processing unit 112 is processing executed by the processor 11. The reception processing unit 111 receives information via the communication unit 13. The transmission processing unit 112 transmits information via the communication unit 13.

The communication unit 13 includes a communication interface for communicating with an external device in accordance with various communication protocols. The processor 11 communicates with other devices via the communication unit 13.

An organization DB 121 and an agent key DB 122 are stored in the nonvolatile memory 12. The organization DB 121 stores information related to an organization registered in the service providing system 1. To be specific, in the organization DB 121, information related to an organization such as a registration date and an organization name is registered in association with an organization ID which is organization identification information for identifying the organization.

The agent key issued to the organization is stored in the agent key DB 122. To be specific, the agent key DB 122 stores the agent key, the organization ID of the organization to which the agent key is assigned, and a serial number that is identification information of the printer to which the agent key is assigned in association with one another. Here, the serial number is an example of device identification information for the service providing apparatus 10 to identify the printer 20, that is, the device. The registration of the agent key to the agent key DB 122 is executed in an agent key setting process, which will be described later. The process will be described in detail later.

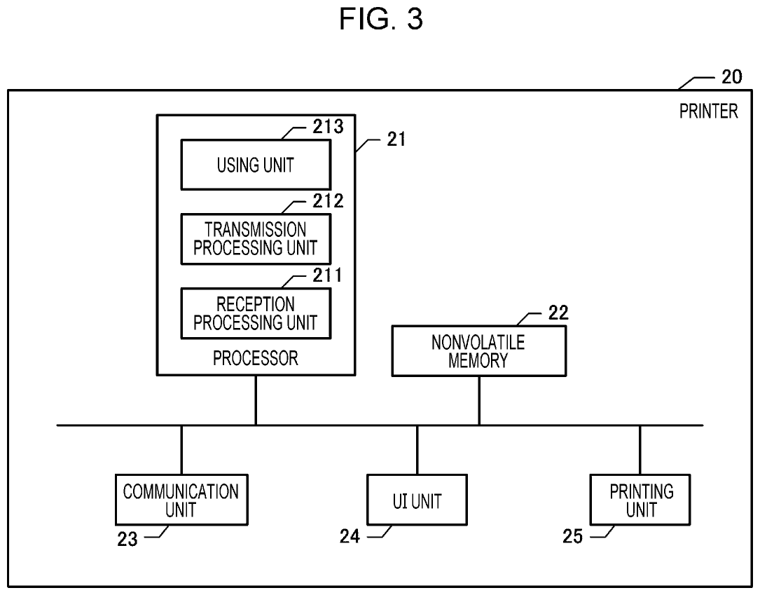

FIG. 3 is a configuration diagram of the printer 20. The printer 20 includes a processor 21, a nonvolatile memory 22, a communication unit 23, a user interface (UI) unit 24, and a printing unit 25. The processor 21 includes a CPU, a ROM, a RAM, and the like (not illustrated), executes various programs recorded in the nonvolatile memory 22, and can control each unit of the printer 20. Similar to the processor 11, various forms are assumed as a hardware configuration of the processor 21.

The processor 21 functions as a reception processing unit 211, a transmission processing unit 212, and a using unit 213 by executing a program stored in the nonvolatile memory 22, the ROM, or the like. That is, in the following description, processing described as being executed by the reception processing unit 211, the transmission processing unit 212, and the using unit 213 is processing executed by the processor 21. The reception processing unit 211 receives information via the communication unit 23. The transmission processing unit 212 transmits information via the communication unit 23. The using unit 213 performs processing using the cloud service.

Similar to the communication unit 13, the communication unit 23 includes a communication interface and communicates with an external device. The processor 21 communicates with other devices via the communication unit 23.

The UI unit 24 includes an operation unit operated by a user and a display unit. To be specific, the UI unit 24 includes a touch panel display, various keys, switches, LEDs, and the like. The touch panel display includes a display panel that displays various kinds of information and a touch detection panel overlaid on the display panel, and detects a touch operation. The processor 21 acquires an operation content of the user via the UI unit 24. In addition, the processor 21 displays various kinds of information on the display unit as the UI unit 24.

The printing unit 25 performs printing on a printing medium. The printing method is not limited, and various methods such as an ink jet method, a toner method, and a sublimation method can be adopted. In addition, the printing medium is not limited to printing paper, and may be various types of printing media such as cloths, ceramics, and resins. The printing unit 25 includes actuators, various apparatuses, sensors, drive circuits, mechanical components, and the like for executing printing on various types of media.

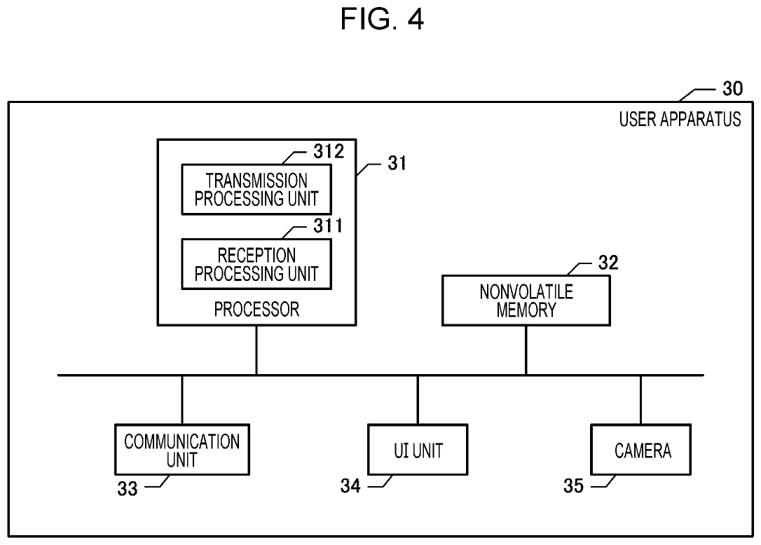

FIG. 4 is a configuration diagram of the user apparatus 30. The user apparatus 30 is a portable information processing apparatus, and includes a processor 31, a nonvolatile memory 32, a communication unit 33, a UI unit 34, and a camera 35. The processor 31 includes a CPU, a RAM, and the like (not illustrated), executes various programs recorded in the nonvolatile memory 32, and can control each unit of the user apparatus 30. Similar to the processor 11 and the processor 21, various forms are assumed as a hardware configuration of the processor 31.

The processor 31 functions as a reception processing unit 311 and a transmission processing unit 312 by executing a program stored in the nonvolatile memory 32, the ROM, or the like. That is, in the following description, processing described as being executed by the reception processing unit 311 and the transmission processing unit 312 is processing executed by the processor 31. The reception processing unit 311 receives information via the communication unit 33. The transmission processing unit 312 transmits information via the communication unit 33.

Similar to the communication unit 13 and the communication unit 23, the communication unit 33 includes a communication interface and communicates with an external device. The processor 31 communicates with other devices via the communication unit 33. The UI unit 34 includes an operation unit operated by the user and a display unit. To be specific, the UI unit 34 includes a touch panel display and the like. The processor 31 acquires an operation content of the user via the UI unit 34. In addition, the processor 31 displays various kinds of information on the display unit as the UI unit 34. The camera 35 captures an image. The camera 35 captures, for example, an image of a two-dimensional code.

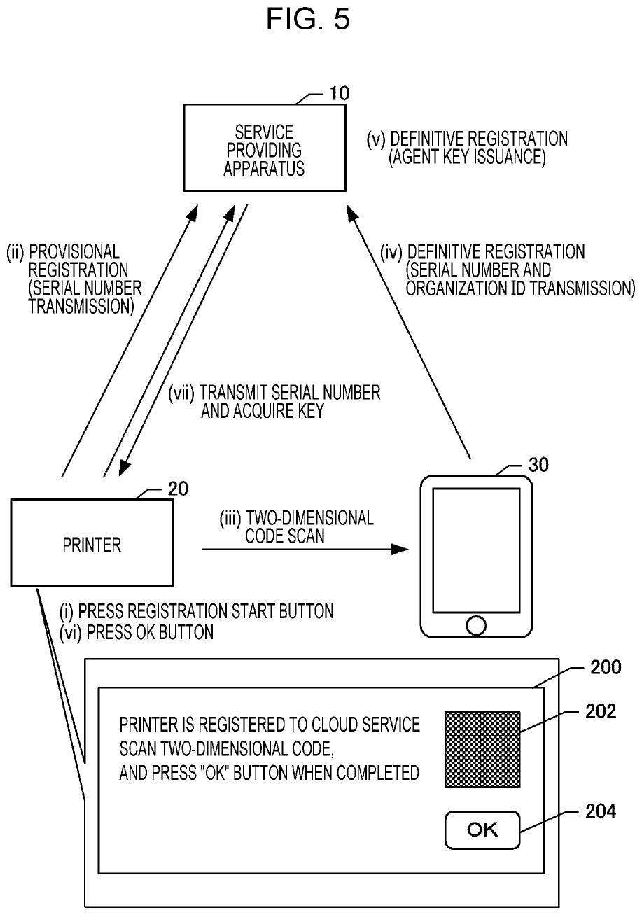

FIG. 5 is a diagram for explaining an outline of the agent key setting process. For the printer 20 to use the cloud service, the agent key issued from the service providing apparatus 10 needs to be set in the printer 20. The setting process is a process in which a member of the organization sets the agent key in the printer 20 to use the cloud service provided by the service providing apparatus 10 by using the printer 20.

In the setting process, first, the user causes the printer 20 to display a printer registration screen and presses a registration start button displayed on the printer registration screen (i). As a result, a serial number of the printer 20 is transmitted from the printer 20 to the service providing apparatus 10, and provisional registration is completed (ii). Then, a printer registration screen 200 is displayed on the display unit as the UI unit 24 of the printer 20. A two-dimensional code 202 is displayed on the printer registration screen 200. The two-dimensional code 202 includes information of the serial number. Here, the two-dimensional code 202 is an example of a code image. Note that, the code image is not limited to an image of a two-dimensional code, and may be a bar code.

In addition, as a premise, it is assumed that the organization to which the user belongs has completed the registration process of registering the organization ID in the cloud service, and the organization ID has been registered in the user apparatus 30. Then, the user operates the user apparatus 30 to complete login to the cloud service, and then causes the printer registration screen to be displayed on the display unit as the UI unit 34. Then, the user follows a guidance and scans (reads) the two-dimensional code 202 with the camera 35. As a result, the user apparatus 30 acquires the serial number of the printer 20 (iii). Then, the user apparatus 30 transmits the serial number to the service providing apparatus 10 in association with the organization ID of the organization to which the user belongs (iv). Upon receiving the serial number and the organization ID, the service providing apparatus 10 issues the agent key in association with the serial number and the organization ID (v). Thus, definitive registration is completed.

Further, after completing the scanning of the two-dimensional code 202, the user presses an OK button 204 displayed on the printer registration screen 200 (vi). When the OK button 204 is pressed, the printer 20 transmits the serial number to the service providing apparatus 10 again. In response to this, the service providing apparatus 10 returns the agent key associated with the received serial number (vii). According to the above process, the setting of the agent key to the printer 20 is completed.

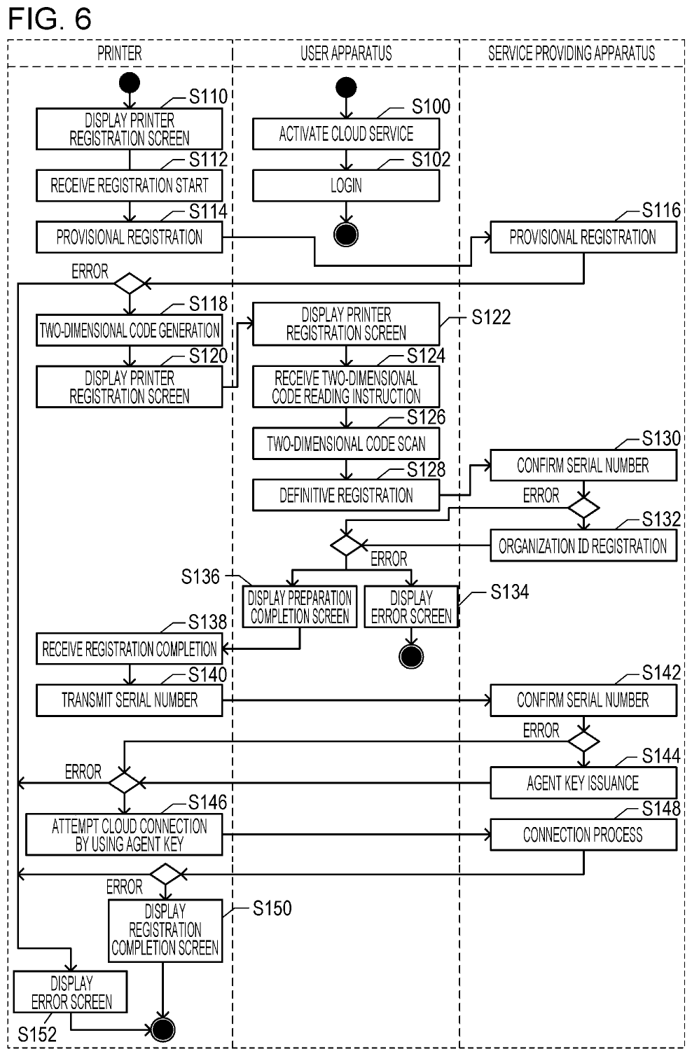

FIG. 6 is a sequence diagram illustrating details of the agent key setting process. As a premise of the setting of the agent key, the user completes login to the cloud service in the user apparatus 30. To be specific, the processor 31 of the user apparatus 30 activates an application of the cloud service (step S100). Next, in response to a user operation, the processor 31 transmits the organization ID of the organization to which the user belongs to the service providing apparatus 10 and performs login to the cloud service (step S102).

Then, for setting the agent key, the processor 21 of the printer 20 causes the display unit to display a printer registration screen in response to an operation of the UI unit 24 of the printer 20 by the user (step S110). Next, when the registration start button is pressed in response to the user operation, the processor 21 receives an instruction to start registration (step S112). Next, the transmission processing unit 212 calls a web application programming interface (WebAPI) for provisional registration and transmits the serial number by the WebAPI for the provisional registration, thereby performing the provisional registration (step S114). When the reception processing unit 111 of the service providing apparatus 10 receives the serial number, the processor 11 performs the provisional registration of the serial number in the agent key DB 122 (step S116).

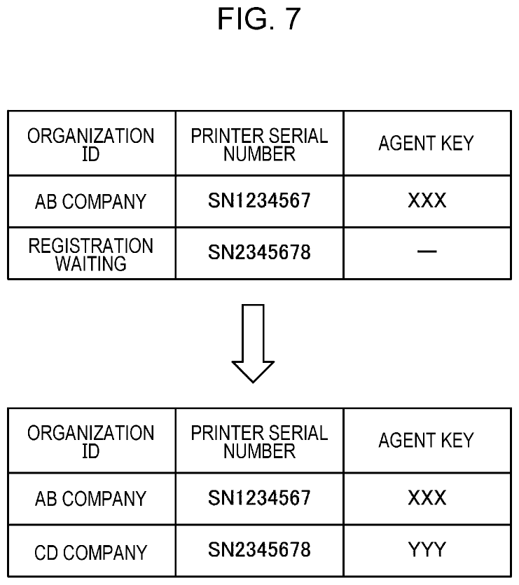

As illustrated in FIG. 7, in the agent key DB 122, the organization ID, the serial number of the printer, and the agent key are stored in association with one another. In the provisional registration of the serial number, the reception processing unit 111 registers the serial number “SN2345678” in the agent key DB 122 as in the second row of the agent key DB 122 illustrated in the upper part of FIG. 7. At this time, the organization ID and the agent key are not registered, and are in a state of waiting registration of the organization ID.

When the provisional registration is completed, the transmission processing unit 112 of the service providing apparatus 10 transmits a provisional registration completion notification to the printer 20. When the provisional registration completion notification is received, the reception processing unit 211 of the printer 20 proceeds the process to step S118. When an error occurs, the processor 21 of the printer 20 proceeds the process to step S152. Note that, the processor 21 determines that an error has occurred when the completion notification is not received for a predetermined period from the transmission of the serial number. Then, in step S118, the processor 21 generates the two-dimensional code preset in the printer 20 and including information of the serial number of the printer 20. Next, the processor 21 causes the two-dimensional code to be displayed on the printer registration screen (step S120).

On the other hand, in response to an operation of the UI unit 34 of the user apparatus 30 by the user, the processor 31 causes the display unit to display the printer registration screen (step S122). Next, when a scan button displayed in the printer registration screen is pressed in response to the user operation, the processor 31 receives a two-dimensional code reading instruction (step S124). Next, the processor 31 scans the two-dimensional code by controlling the camera 35 in accordance with the user operation (step S126). Then, the transmission processing unit 312 calls the WebAPI for the definitive registration, and transmits the serial number included in the two-dimensional code in association with the organization ID of the organization to which the user belongs to the service providing apparatus 10 by the WebAPI for the definitive registration. That is, the transmission processing unit 312 performs the definitive registration (step S128).

The reception processing unit 111 of the service providing apparatus 10 receives the serial number and the organization ID from the user apparatus 30. Then, the processor 11 confirms whether or not the received serial number coincides with the serial number registered in the agent key DB 122 (step S130). Here, the serial number registered in the agent key DB 122 is the serial number transmitted from the printer 20. When the received serial number coincides with the serial number registered in the agent key DB 122, the processor 11 registers the organization ID received together with the serial number in the agent key DB 122 in association with the serial number. Then, the processor 11 transmits a completion notification of the organization ID registration to the user apparatus 30 (step S132). On the other hand, when the received serial number does not coincide with the serial number registered in the agent key DB 122, the transmission processing unit 112 transmits an error notification indicating that the target serial number is not found to the user apparatus 30.

When the error notification is received, the user apparatus 30 causes an error screen to be displayed (step S134) and ends the process. When the completion notification of the organization ID registration is received, the user apparatus 30 causes a preparation completion screen of the printer registration to be displayed (step S136).

After confirming the preparation completion screen, the user presses the OK button 204 displayed on the printer registration screen 200 of the printer 20. In response to this, the processor 21 receives an input of registration completion (step S138). Next, the transmission processing unit 212 calls the WebAPI for acquiring the agent key and transmits the serial number to the service providing apparatus 10 by the WebAPI for acquiring the agent key (step S140).

When the reception processing unit 111 of the service providing apparatus 10 receives the serial number, the processor 11 confirms whether or not the same serial number is registered in association with the organization ID in the agent key DB 122 (step S142). When the serial number is not registered and when the organization ID is not associated with the serial number, the transmission processing unit 112 transmits an error notification indicating that the serial number cannot be confirmed to the printer 20.

When a serial number is registered in association with the organization ID, the processor 11 issues the agent key (step S144). The agent key includes a URL indicating a connection destination when the cloud service is used, and a password for making a connection start request. Then, the processor 11 registers the agent key in the agent key DB 122 in association with the serial number. In addition, the transmission processing unit 112 transmits the agent key to the printer 20. As a result, as illustrated in the lower part of FIG. 7, the organization ID “CD company” and the agent key “YYY” are registered in association with the serial number “SN2345678”.

In the printer 20, when the error notification is received, the processor 21 proceeds the process to step S152. When the agent key is received, the processor 21 proceeds the process to step S146. In step S146, the processor 21 attempts cloud connection by using the agent key. To be specific, the transmission processing unit 212 transmits a connection request to the service providing apparatus 10 together with the agent key. Upon receiving the agent key and the connection request, the processor 11 of the service providing apparatus 10 performs a connection process to the cloud service (step S148). Then, the transmission processing unit 112 transmits a result of the connection process to the printer 20.

When the reception processing unit 211 of the printer 20 receives a notification of success as a result of the connection process, the processor 21 causes a registration completion screen of the printer 20 to be displayed on the display unit (step S150). When the reception processing unit 211 receives a notification of failure as a result of the connection process, and when the result of the connection process is not received for a predetermined time after the connection request is transmitted, the processor 21 proceeds the process to step S152. In step S152, the processor 21 causes an error screen to be displayed. Thus, the setting process is completed.

As described above, in the service providing system 1 of the present embodiment, the user apparatus 30 can acquire the serial number by scanning the two-dimensional code displayed on the printer 20 with the camera 35 of the user apparatus 30. Then, the user apparatus 30 transmits the serial number and the organization ID to the service providing apparatus 10. In the service providing apparatus 10, the processor 11 receives the serial number transmitted from the printer 20 and the serial number transmitted from the user apparatus 30. When the two serial numbers coincide, the processor 11 transmits the agent key to the printer 20.

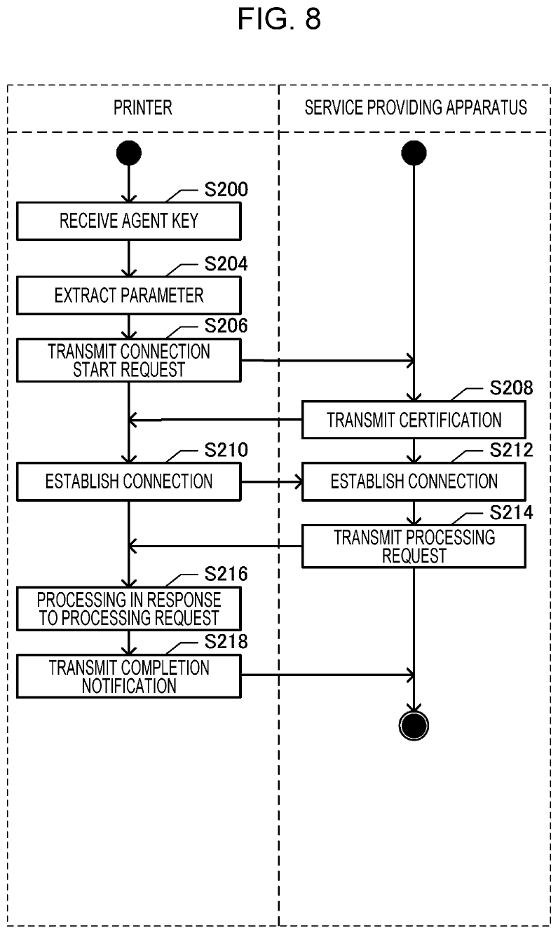

FIG. 8 is a sequence diagram illustrating a service providing process. The service providing process is a process executed when the printer 20 in which the setting process has been completed uses the cloud service. When the agent key is inputted to the printer 20 by the user, the processor 21 receives the agent key (step S200). Next, the processor 21 extracts a URL of a connection destination and a password for making a connection start request as parameters from the agent key (step S204). Next, the transmission processing unit 212 transmits the connection start request together with the password to the service providing apparatus 10 by using the URL of the connection destination (step S206).

When the reception processing unit 111 of the service providing apparatus 10 receives the connection start request, the transmission processing unit 112 transmits a certification to the printer 20 (step S208). Thereafter, the transmission processing unit 112 of the service providing apparatus 10 transmits the certification to the printer 20, and thus a connection is established between the service providing apparatus 10 and the printer 20 (step S210 and step S212). After the connection is established, bidirectional communication between the service providing apparatus 10 and the printer 20 can be performed at any timing.

For example, when a processing request is transmitted from the service providing apparatus 10 (step S214), the using unit 213 of the printer 20 performs processing in response to the processing request (step S216). Then, the transmission processing unit 212 transmits a completion notification to the service providing apparatus 10 (step S218). As described above, after the setting of the agent key is completed, the printer 20 can use the cloud service by using the agent key.

As described above, in the service providing system 1 of the present embodiment, the user apparatus 30 can acquire the serial number from the printer 20. The serial number and the organization ID are then transmitted to the service providing apparatus 10, and when the serial number transmitted from the printer 20 coincides with the serial number transmitted from the user apparatus 30, the service providing apparatus 10 transmits the agent key. Thus, in the service providing system 1, the usage permission information of the service can be accurately set in the device with a simple operation.

In the related art, since the serial number transmitted to a user apparatus is used in the setting of the usage permission information, the correspondence relationship between the serial number and the printer may be erroneously set. In contrast, in the present embodiment, the user apparatus 30 acquires the serial number from the printer 20 by acquiring the two-dimensional code displayed on the printer 20. Therefore, the service providing system 1 of the present embodiment can suppress erroneous setting of the correspondence relationship between the printer and the serial number.

Further, in the present embodiment, the service providing apparatus 10 receives the organization ID together with the serial number from the user apparatus 30, and associates the organization ID with the agent key. Accordingly, device management associating with an organization can be achieved.

### Supplementary Note

The above embodiment is an example for carrying out the present disclosure, and various other embodiments can be adopted. As such a first modification example, the issuance of the agent key and the provision of the cloud service, which are executed by the service providing apparatus 10, may be realized by different apparatuses.

In addition, as a second modification example, in the present embodiment, an example in which a device using the cloud service is the printer has been described, but the device is not limited to the printer as long as the device is configured to use the cloud service.

As a third modification example, the identification information of the printer 20 is not limited to the serial number, and may be any information as long as each apparatus of the service providing system 1 can specify the printer 20.

As a fourth modification example, the process for the user apparatus 30 to acquire the serial number is not limited to the embodiment. As another example, text information (including characters, numbers, and symbols) associated with the serial number may be displayed on the display unit of the printer 20, and the user may input the text information to the user apparatus 30. Note that, the text information in this case may have a number of characters smaller than the serial number. In addition, as another example, the serial number may be transmitted from the printer 20 to the user apparatus 30 by short-range communication such as Bluetooth (registered trademark).

As a fifth modification example, the service providing system 1 may register a device in association with a user instead of an organization. In this case, a user DB is stored in the service providing apparatus 10 instead of the organization DB, and a user ID, which is user identification information for identifying the registered user, is registered in the user DB in association with user information. Further, the user ID is registered in the agent key DB instead of the organization ID. Then, the user apparatus 30 logs in to the service providing apparatus 10 by using the user ID, and may transmit the user ID in association with the serial number to the service providing apparatus 10. Accordingly, device management in a user unit can be achieved.

In addition, the present disclosure can also be applied as a program or a method executed by a computer. Further, the system, the program, and the method as described above may be realized as a single apparatus or may be realized by using components included in a plurality of apparatuses, and include various aspects. In addition, the configuration can be appropriately changed such that part of the configuration is software and part of the configuration is hardware. Furthermore, the disclosure can be realized as a recording medium of a program for controlling the system. Of course, the recording medium of the program may be a magnetic recording medium or a semiconductor memory, and any recording medium to be developed in the future can be considered in the same manner.

What is claimed is:

1. A service providing system, comprising:
a device that uses a cloud service;
a service providing apparatus that provides the cloud service; and
an information processing apparatus, wherein
the device
transmits device identification information for identifying the device to the service providing apparatus,
the information processing apparatus
acquires the device identification information from the device, and
after logging in to the cloud service, transmits the device identification information to the service providing apparatus,
the service providing apparatus
transmits, to the device, usage permission information for permitting use of the cloud service when the device identification information received from the device coincides with the device identification information received from the information processing apparatus, and
the device
uses the cloud service of the service providing apparatus by using the usage permission information.

2. The service providing system according to claim 1, wherein
the device displays a code image indicating the device identification information, and
the information processing apparatus
acquires the device identification information by reading the code image with a camera.

3. The service providing system according to claim 1, wherein
the information processing apparatus
transmits, to the service providing apparatus, together with the device identification information, user identification information for identifying a user whose registration process to the cloud service is performed, and
stores the device identification information, the user identification information, and the usage permission information in association with one another.

4. The service providing system according to claim 1, wherein
the information processing apparatus transmits, to the service providing apparatus, together with the device identification information, organization identification information for identifying an organization whose registration process to the cloud service is performed, and
stores the device identification information, the organization identification information, and the usage permission information in association with one another.

5. A service providing apparatus that provides a cloud service and configured to communicate with a device that uses the cloud service and an information processing apparatus, the service providing apparatus comprising:
a reception processing unit that receives, from the device, device identification information for identifying the device, and further receives, from the information processing apparatus, the device identification information inputted to the information processing apparatus; and
a transmission processing unit that transmits, to the device, usage permission information for permitting use of the cloud service when the device identification information received from the information processing apparatus coincides with the device identification information received from the device.

6. A device configured to communicate with a service providing apparatus that provides a cloud service, the device using the cloud service and comprising:
a transmission processing unit that transmits, to the service providing apparatus, device identification information for identifying the device;
a reception processing unit that receives usage permission information for permitting use of the cloud service, the usage permission information being transmitted from the service providing apparatus when the device identification information transmitted from the device to the service providing apparatus coincides with the device identification information transmitted from an information processing apparatus to the service providing apparatus; and
a using unit that uses the cloud service of the service providing apparatus by using the usage permission information.
